(19) United States
(12) Patent Application Publication
(10) Pub. No.: US 2023/0108874 A1
(43) Pub. Date: Apr. 6, 2023

(54) GENERATIVE DIGITAL TWIN OF COMPLEX SYSTEMS

(71) Applicant: DEEPLIFE, Vernon (FR)

(72) Inventors: Jean-Baptiste MORLOT, Saint-Maur-des-Fossés (FR); Jonathan BAPTISTA, Charenton-le-Pont (FR)

(73) Assignee: DEEPLIFE, Vernon (FR)

(21) Appl. No.: 17/929,015

(22) PCT Filed: Feb. 10, 2021
(86) PCT No.: PCT/EP2021/053231

§ 371 Date: Aug. 10, 2022

(30) Foreign Application Priority Data
Feb. 10, 2020 (EP) 20305123.0

(51) Int. Cl. G06N 3/0475; G06N 3/0455; G06N 3/092

(52) U.S. Cl. CPC G06N 3/0475; G06N 3/0455; G06N 3/092

(57) ABSTRACT

Generating a digital twin of a complex system including receiving at least one training dataset in which each sample includes information on a state and on associated action, including related time information, training a generative model over states, actions and time information to learn a topological space representing attainable system states, in an unsupervised fashion over those states, actions and time information, wherein the generative model learns the mapping to realistic samples includes the space and transitions associated with those samples subject to the actions, and outputting a digital twin including the topological space and transitions between the attainable states subject to the actions, for simulating behaviors of the system by the digital twin to properly achieve one or more tasks pertaining to the system. Applications to reinforcement learning, notably for biological cells.

### TECHNICAL FIELD

The present invention pertains to the field of numeric simulation of complex systems. In particular, the invention relates to generating digital twins of complex systems, such as biological cells, weather or market stocks.

### BACKGROUND ART

Understanding and managing complex systems has become one of the biggest challenges for research, policy and industry. Modeling and simulation of complex systems promises to enable us to understand how biological cells respond to perturbations of their environment, how huge ecosystems adapt to changes, or what actually influences climatic changes. Also, man-made systems are getting more complex and therefore more difficult to predict.

In this context, there is the need to develop methods and tools able to realistically simulate the behavior of complex systems.

However, taking account of evolutions and interactions proper to complex systems proves particularly challenging, all the more since many real-world data are often missing, uncertain, corrupted, hidden or fragmented, leading to sparse and partly uncertain information.

Reinforcement learning (RL), amounting to learn by means of intelligent agents taking actions in an environment so as to maximize a cumulative reward (amounting to a trial and error interaction with an environment directed to learning an optimal policy), appears as a powerful tool for modeling the behavior of such a complex system, insofar as sufficient reliable data taking account of evolutions are available over time. Those data can be iteratively provided from the complex system itself and fed to a relevant model, as and when modifications are introduced into the system based on actions or on action recommendations obtained from the model. This may lead to a strong interaction over time between the real world and a virtual representation of it.

More precisely, the flexible adaptation of the RL model over time is based on minimizing gaps between the prediction of a next state of the complex system by the model on one hand, and the observed effectively obtained state of the complex system on the other hand.

For example, patent application US 2020/0349448 to January Inc. offers an interesting RL combination of real-time exploitation of ground-truth data and of supervised learning, together with generative models, for predicting biophysical responses from biophysical data, such as heart rate monitor data, food logs or glucose measurements. For example, in relation with FIG. 4C, parameters of a body model receiving predictions obtained by an autoencoder are updated via supervised learning based on the biophysical responses (§ 145). Likewise, in relation with FIG. 8, an evaluation system infers predicted values of a biophysical response based on actual and past data, and compares sensor reference values with predicted values for updating models and/or parameter estimators (§ 166-167). Similar principles apply to another evaluation system represented on FIG. 9 (§ 176) and to systems for predicting biophysical responses shown on FIGS. 10 and 11 (§ 180, 183). In addition, missing, corrupted or otherwise unavailable or invalid data may be reconstructed and/or enhanced, by applying generative models to time series (§ 228-315, see notably FIGS. 20C-20D, 33B-33C and 36C-36D), the resulting time series being exploited in RL models.

Though potentially powerful, such achievements rely on constant interactions with the real world so as to ensure regular feeding with ground-truth data, and require substantial real-time processing. This limits their exploitation to specific categories of complex systems, while being unsuited to others.

The gap minimization between prediction and observation of a next state of the complex system (supervised learning) can be instead executed in an upstream overall learning phase, so that a dynamic model becomes later available as a digital twin of the system.

For example, the Undergraduate Thesis by K. P. Kielak entitled “Generative Adversarial Imagination for Sample Efficient Deep Reinforcement Learning”, arXiv: 1904.13255, 2019, develops applications of RL to video games. While generative adversarial networks and Markov property are exploited for training the evolving environment at each time step through an Imagination Module, the time dimension is taken into account by a model-free phase fed with the real environment and following the dynamics of the real environment in a purely supervised learning manner (see notably FIG. 5 and § 4.4-4.5).

Similar achievements are described in the article by A. Piergiovanni et al., “Learning Real-World Robot Policies by Dreaming”, IEEE/IROS, arXiv: 1805.07813, November 2019, in which robot control is learned directly based on images. This is obtained by capturing the dynamics of scene changes conditioned on robot actions through RL. The latter further relies on learning state representations by a variational autoencoder, and on learning a state-transition model by a Convolutional Neural Network exploited in a supervised way involving differences between a future-regressed state and a true future state, and between a predicted future image and a true next image (see notably formula (4)).

Likewise, the Master's Thesis by P. A. Andersen, “Deep Reinforcement Learning using Capsules in Advanced Game Environments”, University of Agder, arXiv: 1801.09597, 2018, develops the use of Deep RL algorithms in advanced game environments, which relies on the Markov property for hidden decision-making (policy) by exploiting model-free Deep Q-learning Networks, and on Capsule Networks coupled with Convolutional Layers for deriving proper actions from states. A current state is conditioned on an action in a generator function for predicting a future state, the RL model being trained in a supervised way by consuming data from an experience replay buffer in minimizing an L2 loss by comparing next-step predictions against real data (see § 5.4).

Another related approach described by D. Ha and J. Schmidhuber in “World Models”, arXiv: 1803.10122v4, 2018, relates to the exploitation of generative neural network models in RL environments, a world model being trained to learn a compressed spatial and temporal representation of the environment. The developed applications regard image frames of video sequences, subject to a variational autoencoder so as to learn a latent representation, and to an RNN (Recurrent Neural Network) coupled with MDN (Mixture Density Network) for predicting a next latent state from a current latent state (via associated probability distributions). Also, a controller model is responsible for determining a course of action from a current latent state (see the Agent model on FIG. 8). As specified in the Appendix (§ A.2), the MDN-RNN is trained using teacher forcing from the recorded data, which consists in forcing the network with an external teacher signal through temporal supervised learning tasks.

The above technologies can prove particularly attractive and efficient for achieving dedicated aims in systems in which a large quantity of regular reference data (whether obtained from the real world or from a virtual world) is readily available over time or can be reasonably completed or adjusted from time series. This may include playing games, notably video games (e.g. above-cited Kielak, Andersen, Ha and Schmidhuber), controlling robots in entrusted tasks through captured images (e.g. above-cited Piergiovanni), or providing health recommendations based on monitored biophysical data (which could be inspired by the January Inc. patent application above).

However, beyond simplest systems, those solutions usually require substantial computation and storage resources. Indeed, the training of a generative model is notably involved at each time step, which may necessitate and produce a huge amount of data, insofar as the generated system model is realistic enough. In addition, such constructions are significantly exposed to prejudicial forgetting, and may even suffer catastrophic forgetting, thus jeopardizing the reliability of all results. Forgetting issues may be at least partly mitigated by increasing the complexity of the models and the volume of processed data. This is however at the cost of further computation and storage requirements.

In addition, the above solutions prove unsuited to complex systems from which only sparse information can be extracted over state and time. Such situations yield so many data gaps that it becomes usually impossible to fill them in a satisfying way, whether by completing or correcting time series or by reconstituting states at given times.

The latter situations could lead to collect, store and process more ground-truth data. However, such information may simply not be available, or getting them may necessitate substantial investments, investigations, or time. Also, gathering, reconstituting and processing sufficient data turns back to the above-mentioned difficulties linked to required computer resources.

### SUMMARY

Preliminary Definitions

In the present disclosure, the following terms have the following meanings:

The terms “adapted” and “configured” are used in the present disclosure as broadly encompassing initial configuration, later adaptation or complementation of the present device, or any combination thereof alike, whether effected through material or software means (including firmware).

The term “processor” should not be construed to be restricted to hardware capable of executing software, and refers in a general way to a processing device, which can for example include a computer, a microprocessor, an integrated circuit, or a programmable logic device (PLD). The processor may also encompass one or more Graphics Processing Units (GPU), whether exploited for computer graphics and image processing or other functions. Additionally, the instructions and/or data enabling to perform associated and/or resulting functionalities may be stored on any processor-readable medium such as, e.g., an integrated circuit, a hard disk, a CD (Compact Disc), an optical disc such as a DVD (Digital Versatile Disc), a RAM (Random-Access Memory) or a ROM (Read-Only Memory). Instructions may be notably stored in hardware, software, firmware or in any combination thereof.

A “complex system” is a real-world entity including multiple interacting aspects and potentially varying over time, due to internal factors corresponding to interactions inside the system and to external factors involving other entities outside the system. At a given time, the complex system is identified by a state expressing its specificities. The complex system may possibly be observable only via sparse collected data over time.

An “action” is a function applied to a complex system so as to transform a state into at least one other state, whether being related to internal factors, external factors, or both. In this respect, multiple actions affecting the complex system at a same time may be globally referred to as a unique action for conciseness.

With respect to a complex system, “time information” may presently refer either to particular moments positioned in an absolute or relative way on a time scale (e.g. expressed in seconds or minutes) or to a mere chronology of states (e.g. one later state coming after a previous state) independently of any particular time scale, which may amount to causal relationships. In this respect, the term “time step” will be broadly used for sake of convenience for designating such a chronology, whether a time value is effectively considered (e.g. by specifying a constant time step value) or not. Accordingly, a state transition reflects a transformation of a state into another as a result of an action, and is so presently considered as providing time information directed to time steps.

An “event” encompasses a state and an associated action, so that chains or sequences of events are expressed over successive time steps leading from an origin state to an arrival state, directly or via one or more intermediary states.

A “Digital Twin” refers to an adaptive model of a complex system, or in other words a digital replica of a part or whole of at least one system, including states and transitions between states subject to actions. For sake of convenience, the same terms “state” and “action” as applied to the complex system are also used for designating respectively related modeling in a corresponding digital twin. It deserves however keeping in mind that the digital twin may comprise a substantially reduced number of states compared with the complex system, in which the number of states can in theory be infinite. In this respect, a given state in the digital twin may correspond to many states of the complex system and/or be selected for representation by contrast with many other non-represented states of the complex system. In fact, even a three-state digital twin may provide precious information on a quite complex system. The digital replica includes data representative of at the very least two states of the system (just enough for state selection), and advantageously at least 1,000, 10,000 or 100,000 states of the system.

A “Manifold” refers to a topological space which in the present disclosure represents the ensemble of the attainable states of a complex system as modeled by a digital twin (the states are “attainable” taking account of the applied actions). As apparent to a skilled person, this meaning is distinct from a usual terminology, according to which in a manifold, each point of the topological space has a neighborhood homeomorphic to a Euclidian space—the latter feature presently corresponds merely to particular implementations.

In the biological field:
“Omic” refers to the collective characterization and quantification of pools of biological molecules that translate into the structure, function, and dynamics of an organism or organisms.
“Bulk sequencing”, refers to sequencing a population of cells without distinctions of the origin of the biological material.
“Single cell sequencing” refers a single experiment or technic allowing analysis of genetic information (DNA, RNA, epigenome, etc.) at the level of a single biological cell. The main difference between single cell and bulk sequencing is that each sequencing sample represents a single cell, instead of a population of cells.

An L1 distance corresponds to the taxicab metric, i.e. using the sum of the absolute differences between values at corresponding Cartesian coordinates, while an L2 distance corresponds to the ordinary Euclidian norm.

Machine learning (ML) designates in a traditional way computer algorithms improving automatically through experience, on the ground of training data enabling to adjust parameters of computer models through gap reductions between expected outputs extracted from the training data and evaluated outputs computed by the computer models.

Datasets are collections of data used to build an ML mathematical model, so as to make data-driven predictions or decisions. Three types of ML datasets (also designated as ML sets) are typically dedicated to three respective kinds of operations: training, i.e. fitting the parameters, validation, i.e. tuning ML hyper-parameters (which are parameters used to control the learning process), and test or evaluation i.e. checking independently of a training dataset exploited for building a mathematical model that the latter model provides satisfying results.

Supervised learning means inferring functions from known input-output examples in the form of labelled training data, exploited by minimizing discrepancies between predicted and known target outputs on the ground of known inputs. This minimization is usually carried out by the means of a similarity cost function, typically based on an L1 or L2 distance. It should be observed that the input-output examples may themselves have been induced from previous digital processing, and thus be somehow artificial rather than pure monitoring products or empirical data. Notably, they may be obtained as compressed, latent or probability distribution data, e.g. as a predicted output and a related known output derived from an available original output by a same generative probability model. In an extreme case, examples are forced during the training (i.e. teacher forcing), which amounts to set the minimization to zero. Also, when combined with unsupervised or weakly supervised aspects further applied to the same input-output examples subject to supervised operations, the learning is presently still considered as supervised insofar as the overall operations rely on the known input-output examples as defined above. In particular, supervised learning based on a previous time step in the frame of reinforcement learning is consistently considered as supervised learning, whatever the way a current state is learned.

Unsupervised learning merely refers to non-supervised learning. Consistently with the definition of the supervised mode, the learning is considered as unsupervised insofar as the overall operations do not rely on known input-output examples as specified above. This does not exclude the use of supervised learning in preparing training datasets, e.g. for completing or correcting time series or inducing relevant data of a second kind from data of a first kind.

A neural network or artificial neural network (ANN) designates a category of ML comprising nodes (called neurons), and connections between neurons modeled by weights. For each neuron, an output is given in function of an input or a set of inputs by an activation function. Neurons are generally organized into multiple layers, so that neurons of one layer connect only to neurons of the immediately preceding and immediately following layers.

A Deep Neural Network (DNN) is an ANN comprising multiple layers (called hidden layers) between an input layer and an output layer.

Sigmoid activation functions, i.e. having an S-shaped curve (such as notably the logistic function) are commonly exploited for ANNs having a finite interval domain. Also, several particular activation functions are commonly exploited for increasing nonlinear properties of an ANN network. They notably concern a Rectified Linear Unit (ReLU, or ramp function), which is an ANN unit outputting the positive part of the argument of an input value; a Leaky ReLU, which further provides for a small positive gradient associated with the negative part (such as a slope of 0.01); and the hyperbolic tangent (tanh).

A Convolutional Neural Network (CNN) is a class of DNN, in which the hidden layers convolve (cross-correlation) with a multiplication or other dot product, each convolutional neuron processing input data only from a restricted subarea of a previous layer, called a receptive field. It usually includes a fully connected layer (i.e. in which neurons have connections to all activations in the previous layer) as the output layer. The activation function of a convolutional neuron is determined by a filter consisting in a vector of weights and a bias.

A Fully Convolutional Neural Network (F-CNN) is a usual contracting network supplemented by successive convolutional layers, where the final convolution layers are followed by an upsampling operation, so that those layers increase the resolution of the output, the input and the output having same spatial dimensions (the F-CNN thereby not needing any fully connected layer). Upsampling may notably be obtained by transposed convolution layers, which rely on transposed convolution matrices and for which the kernel filters can be learned (same connectivity as a normal convolution but in the backward direction).

A U-Net (as notably disclosed by 0. Ronneberger, P. Fischer and T. Brox in the seminal article “U-Net: Convolutional Networks for Biomedical Image Segmentation”, 2015, arXiv: 1505.04597) is built upon an F-CNN by extending the related architecture with an upsampling part having a large number of feature channels, and thereby providing a U-shaped architecture comprising a contracting path (encoder that provides downsampling) similar to a usual CNN and an expansive path (decoder that provides upsampling) more or less symmetric thereto. Skip connections are further provided between the contracting path and the expansive path, allowing the network to propagate context information to higher resolution layers.

A generative ML model involves a statistical model of a joint probability distribution on an observable variable and a target variable (which amounts to uncovering underlying causal relationships between both), which may be a deep generative model (DGM) combining a generative model and a DNN, while a discriminative ML model refers to a conditional probability of a target variable given an observation, or to classification computations without probability model (which amounts to learning a predictor given an observation). In other words, generative models aim at learning a true data distribution of a training set so as to generate new data points with some variations.

A Generative Adversarial Network (GAN) is a DGM involving two ANNs contesting with each other (in terms of data distribution), which enables to generate new data from a given training set by learning: one of the ANNs, called a generative network, generates candidates, while the other ANN, called a discriminative network, evaluates them. Accordingly, the quality of generated images improves as the generative and discriminative networks compete to reach a Nash equilibrium, expressed by the minimax loss of a training process and usually represented by an adversarial loss.

An autoencoder is an ANN learning to copy its input to its output via an internal hidden layer (latent representation) that describes a code representing the input and providing dimensionality reduction (reducing number of features describing data, thereby providing a bottleneck), and which comprises an encoder mapping the input into the code, and a decoder mapping the code to a reconstruction of the input while minimizing reconstruction error.

A variational autoencoder (VAE) is a DGM autoencoder relying on a distribution form of the latent representation, in which the encoder corresponds to a recognition model and the decoder corresponds to a generative model relying on a directed probabilistic graphical model, and which uses a variational approach for latent representation learning (amounting to enforcing a regularization over the distribution of the latent representation though variational inference, typically via a Kullback-Leibler divergence term in an objective function).

Reinforcement learning (RL) refers to goal-oriented algorithms, which learn how to attain a complex objective (goal) or how to maximize along a particular dimension over many steps; for example, they can maximize the points won in a game over many moves. Reinforcement learning can be understood using the concepts of agents, environments, states, actions and rewards. Environments provide frames for turning an action taken in a first state (i.e. current state) into a second state (i.e. new state), which enables to compute a reward associated with the transition from the first state to the second state, while agents are functions transforming a state into an action based on an expected reward. Reinforcement learning represents an agent's attempt to approximate the environment's function, so as to send actions into the black-box environment that maximize the expected cumulative rewards it spits out.

Policy refers to the strategy that an agent employs in reinforcement learning to determine a next action based on a current state. It maps states to actions, the actions that promise the highest reward. Dropout refers to randomly omitting hidden and visible units during the training process of an ANN, and is exploited as a regularization technique for reducing overfitting due to co-adaptation of training data.

One-Hot Encoding (OHE) corresponds to an encoding with a group of bits in which only one bit is allowed to be high (1) and all others are low (0), while One-Cold Encoding (OCE) corresponds to an encoding with a group of bits in which all bits are allowed to be high (1) except one that is low (0).

A zero-inflated model is a statistical model relying on a probability distribution that is suited to frequent zero-valued observations, while a negative binomial distribution is a discrete probability distribution modeling a number of successes in a sequence of independent and identically distributed Bernoulli trials until a predetermined number of failures occurs. Accordingly, a Zero-Inflated Negative Binomial model (ZINB) combines related specificities.

A Bernoulli process is a sequence of binary random variables, which are identically distributed and independent.

The ML terminology and definitions are compliant with their most up-to-date usual meaning (except where stated otherwise), and can be completed with numerous associated features and properties, well known to a person skilled in the ML field.

Additional terms will be defined, specified or commented wherever useful throughout the following description.

Objects of the Disclosure

The present disclosure relates to a computer-implemented method for generating a digital twin of a complex system, compliant with claim 1.

The method may comprise:
receiving at least one training dataset comprising N samples, each sample including information on a state of the complex system;
training a generative model to learn a manifold which represents the variability of the training dataset, in an unsupervised fashion; wherein the generative model has learned the mapping to realistic samples comprised in the manifold;
optionally validating the manifold obtained with the generative model using a validation dataset;
outputting a digital twin being the (possibly validated) manifold representing the ensemble of the attainable state of the complex system.

In spite of its apparent simplicity, the present method provides with respect to the state of the art a significant paradigm shift in the modeling construction adapted to reinforcement learning. Namely, while existing solutions involve coupled training between reinforcement learning and model learning, in which each time step relies on the previous one by means of supervised operations, complete decoupling may be possible in the present method by means of unsupervised learning, i.e. without relying on supervised operations based on a previous time step. Nonetheless, the obtained digital twin may be fully relevant to reinforcement learning, thereby potentially allowing complete operations in this virtual world properly reflecting the represented complex system, without explicitly referring then to ground truth or derived values.

The role of unsupervised learning appears pivotal in such achievements, since supervised learning (with respect to previous time steps) so far curtailed opportunities, while being considered as necessary for extracting proper value from complexity. Unsupervised learning may unlock the stepwise dependency of the learning over time or causality, and enables to consider the potential events globally in the frame of the training, including transitions between states and chains of actions.

The present approach may provide substantial computation and storage gains in training the ML models, due to the overall consideration of states, actions and time information. Namely, the set of parameters may be globally adjusted so as to capture maximum information involving hidden relationships and interconnections between those distinct entities. Also, the dimensionality and complexity of the digital twin may be flexibly adjusted, thereby offering precious leeway in reaching proper efficiency-reliability tradeoffs. This contrasts with existing models, in which the training must be reliable enough at each time step and impacts the later periods.

The very nature of model learning computing for RL is thus basically changed, potentially affecting computational efficiency in a substantial way in a number of cases, and opening new ranges of opportunities for further developments and applications.

In particular, building autonomous digital twins suited to reinforcement learning becomes possible for new kinds of real-world situations, even when reflecting a high level of complexity, e.g. directed to medical or industrial diagnostic, development of new drugs or of effective industrial processes, or safety of transport vehicles or space systems.

In particular modes, in training the generative model, at least part of the states, actions and time information of the N samples is encoded for the training.

The encoding is then executed upstream the generative operations of the training as such. It may be applied to the states alone, to the actions alone, to the time information alone (which may e.g. include time values or mere time step numbers), or to any combination thereof. It may rely on a random process, e.g. a Bernoulli process. It may be binary.

According to particular encoding modes, in training the generative model, at least part of the states of the N samples is subject to a binary mask.

According to other particular encoding modes, which may be combined with the previous ones, in training the generative model, at least part of the actions and time information of the N samples is subject to a one-hot encoding.

In alternative implementations, in training the generative model, the time information is encoded as sine and cosine functions (as done e.g. with transformers).

According to one embodiment, the generative model is selected among a generative adversarial network, invertible generative model, normalization flows, a variational autoencoder and a transformer.

According to one embodiment, the at least one training dataset is preprocessed for data homogenization and harmonization in distribution.

According to one embodiment, the method comprises mapping the dataset to a latent space in training the generative model.

The method for generating a digital twin may be relevant to one task or to multiple tasks pertaining to the complex system, depending on state, action and time information modeling. A given task may further be multiple, e.g. decreasing power consumption and costs in a building while providing efficient lighting, heating and computing services, or predicting drug efficiency together with side effects in biological cells.

According to particular embodiments, the complex system is selected among:
a weather of an area, the task(s) to be achieved including e.g. at least one of predicting a weather state in that area or in a nearby area, and optimizing agricultural provisions in relation with that area or nearby area,
a city, the task(s) to be achieved including e.g. at least one of predicting at least one of a traffic congestion, a pollution level and a power consumption, reducing traffic congestion, and reducing a pollution level in that city,
a building, the task(s) to be achieved including e.g. at least one of predicting at least one of a pollution level and power consumption, reducing energy expenses, and reducing a pollution level in that building,
at least one of a production line and a power plan, the task(s) to be achieved including e.g. at least one of predicting a failure state, increasing profitability, and reducing expenses,
a vehicle selected among a car, a plane, a drone, a boat, a submarine and a spacecraft, the task(s) to be achieved including e.g. at least one of reducing power consumption and enhancing transport safety,
a brain, the task(s) to be achieved including e.g. at least one of reducing capacity losses in degenerative diseases, enhancing capacities after brain damage and reactivating partially atrophied areas,
a biological cell, the task(s) to be achieved including e.g. at least one of predicting disease evolution, predicting drug efficiency, predicting drug effect, predicting drug resistance, performing drug enhancement in fighting against a given disease, performing drug enhancement for a given patient, predicting cell productivity for given chemical compounds (bio-production).

According to one embodiment where the complex system is a biological cell, the information on a state comprises at least one item of the following: omics data, such as notably genomic data, proteomic data, transcriptomic data, epigenomics data or metabolomic data, and/or imaging data.

According to one embodiment, the omics data are single cell sequencing data or bulk sequencing data.

According to one embodiment where the complex system is a biological cell, the information on a state further comprises a velocity.

The present disclosure further relates to a computer-implemented method for providing a sequence (optimal in some advantageous achievements) of actions causing the evolution of a complex system from an initial state to a final state, the method comprising:
generating a digital twin of the complex system with a method according to any of the above execution modes;
coupling a reinforcement learning algorithm to that digital twin of the complex system;
using a policy of the reinforcement learning algorithm to select at least one action to be performed according to an action selection policy and to provide the selected one or more actions to the digital twin, the latter being configured to implement the selected at least one action to generate an output, and by updating parameters of the policy using a reinforcement learning procedure according to a reward signal determined from the output (e.g. from a discriminator), so that the digital twin is iteratively turned from an initial state to a final state, said initial state and final state representing said initial state and final state of the complex system;
outputting the sequence of actions relevant to the complex system and corresponding to the iteratively selected action(s) obtained with the reinforcement learning algorithm applied to the digital twin.

The reward signal may be determined in function of the task(s) to be achieved pertaining to the complex system.

According to one embodiment, at least one value obtained from an iteration of the method is used as the initial state.

According to one embodiment, the reward signal is determined as a distance to the final state.

According to one embodiment, the reinforcement learning algorithm comprises at least one constraint received as input from a user.

In advantageous implementations, the outputted sequence of actions relevant to the complex system is exploited for properly achieving any of the tasks as recited above about the method for generating a digital twin.

Another object of the disclosure is a device for generating a digital twin, compliant with claim 13.

In advantageous implementations, the device is configured for executing a method for generating a digital twin according to any of its execution modes (i.e. the device may be configured for executing a single one of those modes, or for executing any two or more of those modes).

A further object of the disclosure is a device for providing a sequence of actions compliant with claim 14.

The present disclosure also relates to a computer program product comprising instructions which, when the program is executed by a computer, cause the computer to automatically carry out the steps of a method for generating a digital twin or of a method for providing a sequence of actions according to any one of the embodiments described hereabove (i.e. the instructions may cause the computer to carry out the steps of the method according to a single one of those embodiments, or any two or more of those embodiments).

The present disclosure also relates to a non-transitory computer readable storage medium comprising instructions which, when the program is executed by a computer, cause the computer to carry out the steps of the method according to any one of the embodiments described hereabove.

Such a non-transitory program storage device can be, without limitation, an electronic, magnetic, optical, electromagnetic, infrared, or semiconductor device, or any suitable combination of the foregoing. It is to be appreciated that the following, while providing more specific examples, is merely an illustrative and not exhaustive listing as readily appreciated by one of ordinary skill in the art: a portable computer diskette, a hard disk, a ROM, an EPROM (Erasable Programmable ROM) or a Flash memory, a portable CD-ROM (Compact-Disc ROM).

### BRIEF DESCRIPTION OF THE DRAWINGS

The present disclosure will be better understood, and other specific features and advantages will emerge upon reading the following description of particular and non-restrictive illustrative embodiments, the description making reference to the annexed drawings wherein:

FIG. 1 is a block diagram showing the main steps of the method for generating a digital twin of a complex system according to one embodiment.

FIG. 2 is a schematic representation of the method for providing a sequence of actions causing the evolution of a complex system from an initial state to a final state.

FIG. 3 is a block diagram representing schematically a device for generating a digital twin and a cooperating device for providing a sequence of actions compliant with the present disclosure.

FIG. 4(a) is a schematic representation of the method for generating a digital twin of a complex system and FIG. 4(b) is a schematic representation of the method for providing a sequence of actions causing the evolution of a complex system from an initial state to a final state. In this schematic representation, the arrows represent states velocity.

FIG. 5 represents the architecture of a generative model compliant with the method of FIG. 1 and the device of FIG. 3, used for generating a digital twin pertaining to the response of a biological cell to a perturbation such as a drug.

FIG. 6 diagrammatically shows an apparatus integrating the functions of the device for generating a digital twin and the device for providing a sequence of actions of FIG. 3.

On the figures, the drawings are not to scale, and identical or similar elements are designated by the same references.

### DETAILED DESCRIPTION

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein may represent conceptual views of illustrative circuitry embodying the principles of the disclosure. Similarly, it will be appreciated that any flow charts, flow diagrams, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, a single shared processor, or a plurality of individual processors, some of which may be shared.

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces.

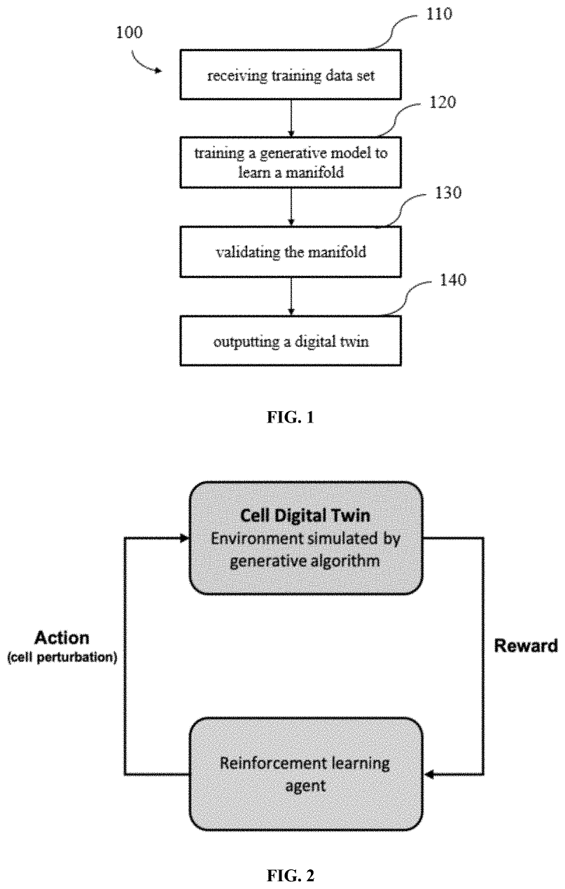

The present disclosure relates to a computer-implemented method for generating a digital twin of a complex system. As a schematic representation, the main steps of the method 100 are represented in FIG. 1.

The method comprises a preliminary step 110 consisting in receiving at least one training dataset comprising N samples, each sample including information on a state of the complex system. In one embodiment, the information on the state of the complex system comprises intrinsic parameters and/or extrinsic parameters of the complex system. For intrinsic parameters is has to be understood all internal parameters of the system and for extrinsic parameters all parameters describing the system by that do not depend only on the system itself.

According to one embodiment, the complex system is a biological cell. The biological cell may be selected from the group consisting of human cells, animal cells, vegetal cells, fungi, yeasts, microorganisms.

In some embodiments, the method is configured to receive as input a number N of samples ranging from 1 hundred to 20 million, and in more specific modes, from 1 million to 20 million, or from 5 million to 15 million. In some implementations, the number of samples is determined in function of the conditions and cell types. The number of samples per condition and per cell type may notably range between 1 hundred and 10 thousand, and be more particularly worth around 5 thousand. Such embodiments may enable to obtain a good quality level of the digital twin generation by confronting the learning model with a large number of biological cell states.

Thus for example, the method may be related to multiplexed RNA sequencing for transcriptional profiling, as described in the frame of multiplexed droplet single-cell RNA sequencing by H. M. Kang et al. in “Multiplexed droplet single-cell RNA-sequencing using natural genetic variation”, Nature Biotechnology, 36(1), January 2018, involving approximately 5,000 cells (i.e. samples) per cell type and condition, or in the frame of pharmacologic or genetic perturbations of cancer cells by J. M. McFarland et al. in “Multiplexed single-cell transcriptional response profiling to define cancer vulnerabilities and therapeutic mechanism of action”, Nature Communications, 11, 4296, August 2020, involving approximately 200 cells per cell type and condition.

In one embodiment, the complex system being a biological cell, the information on a state comprises at least one item of the following: omics data, such as genomic data, proteomic data, metabolomic data, transcriptomic data or epigenomics data, and/or imaging data. The advantage of this embodiment is to gain a better understanding at the molecular level of major biological topics such as: cancer, stem cells, aging, as well as the development of drug resistance.

According to one embodiment, the omics data are single cell sequencing data or bulk sequencing data.

In this embodiment, the at least one training dataset is preprocessed for data homogenization and harmonization in distribution, using for example zero-inflated negative binomial.

According to one embodiment, the method comprises the step 120 of training a generative model to learn a manifold which represents the variability of the training dataset, in an unsupervised fashion, wherein the generative model learns the mapping to realistic samples comprised in the manifold. Indeed, the data are modeled as they are lying on this low-dimensional manifold embedded in the high-dimensional ambient space.

According to one embodiment, the generative model is a generative adversarial network (GAN), normalizing flows, an autoencoder, notably a variational autoencoder, normalization flows or invertible generative models.

Variational Autoencoder allows to learn the complicated data distribution such as the ones of complex system using neural networks in an unsupervised fashion. It is a probabilistic graphical model rooted in Bayesian inference i.e., the model aims to learn the underlying probability distribution of the training data so that it could easily sample new data from that learned distribution. The idea is to learn a low-dimensional latent representation of the training data called latent variables (variables which are not directly observed but are rather inferred through a mathematical model) which we assume to have generated our actual training data. A variational autoencoder can be defined as being an autoencoder whose training is regularized to avoid overfitting and ensure that the latent space has good properties that enable generative process. A variational autoencoder is an architecture composed of both an encoder and a decoder and that is trained to minimize the reconstruction error between the encoded-decoded data and the initial data. However, in order to introduce some regularization of the latent space, the variational autoencoder comprises a slight modification of the encoding-decoding process: instead of encoding an input as a single point, the variational autoencoder encodes it as a distribution over the latent space. The model is then trained as follows: first, the input is encoded as distribution over the latent space, second, a point from the latent space is sampled from that distribution, third, the sampled point is decoded and the reconstruction error can be computed and finally, the reconstruction error is backpropagated through the network.

In a very basic implementation, the training data are entered as available chains of states and actions, i.e. state-action-state-action-state . . . , whatever the lengths of those chains (which may even cover a single transition, i.e. state-action-state).

Even though the obtained digital twin is coarse, it may anyway provide quite helpful information in executing reinforcement learning on this ground. It is noted that in such embodiments, the time steps (i.e. the order of the events) are taken implicitly into account via the positioning of the elements in the chains.

In enhanced versions involving an encoder-decoder structure (which may be a VAE or not), time steps are expressly taken into account. This can be done by a mechanism designated as “Transformers” and described in the seminal article by A. Vaswani et al., “Attention Is All You Need”, NIPS 2017, arXiv: 1706.03762.

According to that technology, self-attention is entirely relied upon to compute representations of the model input and output (without using sequence-aligned Recurrent Neural Networks or convolution). The encoder maps an input sequence of symbol representations x (the sequence length n being the number of symbol representations) to a sequence of n continuous representations z, while the decoder generates an output sequence of symbols y (length m) from z one element at a time, the model being auto-regressive (the previously generated symbols are consumed as additional input for generating the next). More precisely, in each layer of the encoder, a multi-head self-attention mechanism is implemented followed by a position-wise fully connected feedforward network, completed by a residual connection around each of the sub-layers and followed by layer normalization. In the decoder, layers respectively corresponding to those of the encoder are implemented, further including a third sub-layer performing multi-head attention over the output of the encoder stack. In addition, in the upstream sub-layer of the decoder, a masking mechanism prevents positions from attending to subsequent positions. Positional encoding is injected into the model for reflecting the order of the sequence, in the form of sine and cosine functions of different frequencies that depend on the position order.

Accordingly, times themselves may be taken into account implicitly, specially when time series having a fixed time step are available or can be induced.

In particular applications of the Transformers model to the present disclosure, the sequence length corresponds to a maximum number of time steps in chains of events (i.e. number of states in the chains of actions), and incomplete chains are padded with zero values following the ends of those chains so as to get a constant length for all chains. The positional encoding reflects the chronological order in the chains. Also, the states and actions are provided to the Transformers model as pairs of the sequence items so as to be processed jointly.

In alternative embodiments, the actions are concatenated to the associated states in forming the sequence items.

In variants, the states and actions are provided as triplets including a current state xₙ, a current action aₙ, and a next state xₙ₊₁, which may enable to strengthen taking account of the causality links in the learning process. In the same way as for the pairs, those data may be concatenated.

In some modes, where no information or very limited information is available for part of time steps inside chains, whether regarding the states or the actions, the corresponding time steps are ignored, so that only time steps for which available data can be exploited are used as inputs. Accordingly, chains of events may have various lengths. This may notably lead to chains having a same length but corresponding to different, possibly quite different, durations. This limitation does not prevent the learning operations from putting forward potential hidden causal relationships between events. Such achievements can be useful in case causality and event chaining are essentially considered, rather than evolution timing.

In alternative embodiments, items deprived of reliable information for part of the time steps are masked, e.g. set to zero. Combined with padding, this may notably enable to keep a constant length for the chains, e.g. given by the maximum number of available time steps. Insofar as sufficiently diversified and bulky information is available in the training dataset, the present method may then be able to fill the gaps by reconstituting missing behaviors.

In other modes, where no, limited or corrupted information is available for some time steps inside action chains, interpolations are executed by any method known to a person skilled in the art so as to complete or adjust a training dataset. Such interpolations may be spatial and/or temporal, and may e.g. be derived from ML methods, such as neural networks. They may rely on generative models involving unsupervised learning (e.g. VAE or GAN). Alternatively or in combination, they may rely on supervised learning (e.g. with Multi-Layer Perceptron networks or Convolutional Neural Networks)—which, as mentioned above, does not jeopardize the unsupervised nature of the model learning as such.

Even where training datasets are completed in such ways, relying thereon by proceeding with unsupervised learning for the generation of the digital twin instead of supervised learning may remain attractive for complex systems. Indeed, a lower level of refinement may be necessary, and a global training may be executed instead of successive training operations at each time step, thereby providing potentially substantial memory and computation gains. Also, integrating time or causality dimension in the training may uncover hidden relationships, possibly partly concealed by the preparation of the completed or corrected dataset, which would otherwise remain invisible through supervised learning.

In addition to or instead of mere time steps, i.e. time sequence ordering, time values themselves may be included in the model as specific parameters. They may be entered into the generative model and contribute to the latent representation. Encompassing time values further to states and actions may be particularly attractive when available information is sparse over time.

Other versions involving an encoder-decoder structure exploit Transformers achievements as described by G. Zerveas et al. in “A Transformer-Based Framework for Multi-Variate Time Series Representation Learning”, arXiv: 2010.02803v3, December 2020. Those solutions are expressly directed to unsupervised representation learning of multivariate time series (instead of sequences of discrete word indices). Each training sample is then a multivariate time series of length w and m different variables, constituting a sequence of w feature vectors. In the training setup of an unsupervised pre-training task, a proportion r of each variable sequence in the input is masked independently, such that across each variable, masked time segments of mean length lₘ alternate with unmasked segments of mean length lₘ×(l−r)/r. On this ground, only predictions on the masked values are considered in exploited losses. In addition, contrary to the teaching of the seminal article above on Transformers, positional encodings are fully learned.

In particular applications of that Transformer-based framework to the present disclosure, multivariate time-series are obtained by coupling states and corresponding respective actions. In other embodiments, states and respectively corresponding actions are concatenated. Also, missing data inside chains of actions may be ignored, masked or completed as mentioned above.

According to other Transformer-based methods used in embodiments of the present disclosure, Position Encoding is performed as described by X. Liu et al. in “Learning to Encode Position for Transformer with Continuous Dynamical Model”, arXiv: 2003.09229, March 2020. Namely, instead of applying a fixed sinusoidal function to position representations or of including the latter as uncorrelated learnable parameters, which may fail to capture dependency or dynamics among the position representations, a dynamical system is used to model them. This takes the form of a neural network adapted to an Ordinary Differential Equation problem (ODE, equation (8) of the article), related parameters being advantageously shared between Transformer blocks.

The learning operations may be stimulated by masking part of the entry data, whether regarding the state, the action, the time information, or any related combination. This masking may be randomly introduced. It may take the form of OHE (One-Hot Encoding) or OCE (One-Cold Encoding), particularly regarding time steps.

Inference operations at running stages may keep data structures identical or similar to the ones used in the learning phase. Potentially relevant and realistic chains of events, involving system states, actions and possibly time information (which may include time step positions or time values), may thereby be generated by changing one of the data entries, by modifying entry state, action and/or time information.

For example, supposing a VAE is fed with a chain of events of the kind:
(x₁, a₁, t₁; x₂, a₂, t₂; x₃, a₃, t₃)

with xᵢ, aᵢ and tᵢ representing respectively states, actions and time information (i=1, 2, 3), a new chain of events may be generated in the inference phase by replacing some of the entry data. For instance, inputting:
(x₁, a₁, t₁; x₂, a₂, t₄; x₃, a₃, t₅)

instead of the above training chain may provide an automatically created chain of states (x₁, a₁, t₁; x₄, a₄, t₄; x₅, a₅, t₅) insofar as the starting conditions (state, action and time information) are enforced during the training (e.g. by conditional learning).

Instead of changing time information, one or more of the states may be modified in the entered chain, e.g. by inputting:
(x₁, a₁, t₁; x₄, a₂, t₂; x₅, a₃, t₃)

so as to generate new state evolutions (x₁, a₁, t₁; x₄, a₄, t₄; x₅, a₅, t₅).

In implementations ignoring time (but in which time information is implicitly present in the event ordering), a VAE is fed with a chain of events of the kind:
x₁, a₁; x₂, a₂; x₃, a₃)

and a new chain of events may be generated in the inference phase by replacing some of the entry data. For instance, inputting:
x₁, a₁; x₄, a₂; x₅, a₃) instead of the above training chain may provide an automatically created chain of events (x₁, a₁; x₄, a₄; x₅, a₅) insofar as the starting conditions (state and action) are enforced during the training (e.g. by conditional learning).

The purely illustrative chains above including three steps may be replaced with chains of any length depending on the kind of applications, e.g. at least 10, 100 or 1000 steps. Conversely, in particular implementations, the chain of events comprises only 2 steps, or is reduced to a single step. For example, supposing a VAE is fed with (x₁, a₁, t₁), a new event may be generated in the inference phase by replacing some of the entry data. For instance, inputting (x₁, a₁, t₂) may provide an automatically created event (x₂, a₂, t₂).

The above bracket notation represents any appropriate data structure, which may notably rely on parallel entries of states, actions and/or time information, concatenations of part or all of them into vector forms, expressions as state-action pairs or current state-current action-next state triplets optionally completed with time, and may involve transformations such as e.g. positional encoding applied to time as known for Transformers.

Also, any entry may be modified as suited to the followed running exploitation strategy, whether alone or in combination with other entries.

The inference operations may in particular be repeatedly executed at a stage of reinforcement learning, as explained below.

Generative Adversarial Networks do not work with any explicit density estimation like Variational Autoencoders. In a GAN, two neural networks, a generative network and a discriminative network, contest with each other in a game. Given a training set, this technique learns to generate new data with the same statistics as the training set. The generative network generates candidates while the discriminative network evaluates them. The contest operates in terms of data distributions. Typically, the generative network learns to map from a latent space to a data distribution of interest, while the discriminative network distinguishes candidates produced by the generator from the true data distribution. The generative network's training objective is to increase the error rate of the discriminative network (i.e., “fool” the discriminator network by producing novel candidates that the discriminator thinks are part of the true data distribution).

Instead of a single cost function optimization, it aims at the Nash equilibrium of costs, increasing the representative power and specificity of the generative model, while at the same time becoming more accurate in classifying real from generated data and improving the corresponding feature mapping.

In one example, the GAN may consist of many convolutional, deconvolutional and/or fully connected layers. The network may as well use many deconvolutional layers to map the input noise to the desired output image. Batch Normalization may be used to stabilize the training of the network. ReLU activation may be used in generator for all layers except the output layer which uses tanh layer and Leaky ReLU may be used for all layers in the Discriminator. This network may be trained using mini-batch stochastic gradient descent and Adam optimizer was used to accelerate training with tuned hyperparameters.

In particular, the generator and the discriminator may comprise F-CNN networks, and the generator may more specifically have a U-Net architecture.

In another example the GAN is a conditional GAN which is constructed by simply adding conditional vector along with the latent vector. By conditioning the model on additional information which is provided to both generator and discriminator, it is possible to direct the data generation process.

In a very basic implementation, the training data are entered as available chains of states and actions, i.e. state-action-state-action-state..., whatever the lengths of those chains (which may even cover a single transition, i.e. state-action-state).

Even though the obtained digital twin is coarse, it may anyway provide quite helpful information in executing reinforcement learning on this ground.

Also, entry data including states, actions and/or time information may be encoded for generative operations with GAN in a similar way as presented above for autoencoders.

Inference operations at running stages may keep data structures identical or similar to the ones used in the learning phase. Potentially relevant and realistic chains of events, involving system states, actions and possibly time, may thereby be generated by changing one of the data entries, by modifying entry state, action and/or time values, similarly to operations described above for autoencoder generative models. For example, time may be encoded with sine and cosine functions, in a similar way as described in the seminal 2017 article by Vaswani et al. In alternative embodiments, time is included as uncorrelated learnable parameters. In still other implementations, time is shared between blocks and subject to an ODE, as developed in the above-cited 2020 article by Liu et al.

As will be apparent to a person skilled in the art, the same principles as developed above may be implemented in various other ways, notably involving latent spaces and/or adversarial processes.

In one embodiment, the generative model is a reversible generative model. Reversible networks (RevNets) are neural networks that are invertible by design through the use of invertible blocks.

In one embodiment, the method comprises before step 120 a step of mapping the dataset to a latent space. In this embodiment, the generative model has learned the mapping from the latent space representation to realistic samples comprised in the manifold.

According to one embodiment, the method of the present disclosure comprises the step of validating the manifold 130 obtained with the generative model using a validation dataset. Validation may include computing the distance of the generated samples to the real data manifold in terms for example of probabilistic distance. A high precision implies that the generated samples are close to the data manifold, and high recall shows that the generator outputs samples that cover the manifold well.

According to one embodiment, the method further comprises the step 140 of outputting a digital twin including the validated manifold representing the ensemble of the attainable states of the complex system. For attainable state it has to be understood any realistic state in which a complex system may be.

According to one embodiment, the information on a state further comprises a velocity (which may be a speed of transition from that state to a next one). When the complex system is a biological cell, the velocity is the velocity of transition from a first state of the cell to a contiguous second state of the cell on the manifold.

The method for generating a digital twin of a complex system advantageously allows the generation of models capable to realistically reflect complex system behavior in a given environment.

The complex system may be at least one organ such as the brain or a plurality of body parts.

In one embodiment, the complex system is one of the following: stock market, weather of a region, a city, a production line, an insurance, a social network, a personalized education or information system, a “smart” building, an in silico organ-on-a-chip, or an advertisement.

In one example where the complex system modeled by the digital twin is a stock market, the training set comprises share prices. The internal parameters of the system are share values and time periods while the external parameters are the news, global stock exchange etc. The associated actions may include e.g. buying or selling shares, or modifying exchange rates. The output provided by the digital twin of a stock market is e.g. the predictive state of the share.

In one example where the complex system modeled by the digital twin is the weather of an area, the training set comprises parameters such as the atmospheric pressure, temperature, wind velocity in said area. The internal parameters of the system are the area configuration (field, city, forest), activity in the area, local atmosphere while the external parameters are the information concerning nearby areas, sun activity, etc. The associated actions may include e.g. setting temperatures or pressures, or applying wind streams. The output provided by the digital twin of the weather of an area is e.g. the predictive state in the area or nearby area.

In one example where the complex system modeled by the digital twin is a city or a “smart” building, the training set comprises parameters such as the traffic state, the temperature, the weather conditions, the pollution levels, power consumption etc. The internal parameters of the system are the city configuration or “smart” building configuration and the like, while the external parameters are news, political decisions, weather, etc. The associated actions may include e.g. controlling the traffic, modifying heating or reducing pollution. The output provided by the digital twin of a city or a “smart” building is e.g. a predictive state of congestion in the city or congestion in the “smart” building, pollution level, power consumption etc.

In one example where the complex system modeled by the digital twin is a production line or a power plan, the training set comprises parameters such as number of elements produced, machine sensors, employee time table, etc. The internal parameters of the system are the room temperature and the like, while the external parameters are the news, company decision, etc. The associated actions may include e.g. increasing or decreasing the production rates, modifying the temperature, or adjusting the working hours. The output provided by the digital twin of the production line or the power plan is e.g. a predictive failure state.

In one example where the complex system modeled by the digital twin is a Social Network, the training set comprises information such as Historic of publications (Who and What contents). The internal parameters of the system are views, likes etc. while the external parameters are social climate, political decisions etc. The associated actions may include e.g. enhancing advertising, increasing control levels or modifying the social climate. The output provided by the digital twin of the Social Network is e.g. a predictive state of the social acceptance (number of views/likes).

In one example where the complex system modeled by the digital twin is cell/organ/in silico organ-on-a-chip/body, the training set comprises parameters such as bio data, omics, clinical data etc. The internal parameters of the system are bio parameters (ARN, prot, molecules level, images) and the like, while the external parameters are environment, eating, pollution, age, sex, etc. The associated actions may include e.g. introducing a drug or modifying its properties or administration conditions, setting a level of cell activity, or modifying a degree of pollution. They may pertain to any other kind of perturbation, including notably via a drug, a virus, gene editing, changes in temperature, pressure and/or light. The output provided by the digital twin of cell/organ/in silico organ-on-a-chip/body is e.g. the state after a perturbation of the complex system.

In one example where the complex system modeled by the digital twin is a brain, the training set comprises images (scanner/IRM/ . . . ) and/or electric signals from neurons. The associated actions may include e.g. increasing or decreasing the degree of neural activity, modifying the rest durations including deep sleep or paradoxical sleep, or stimulating specific brain areas.

In one example where the complex system model by the digital twin is car-plane-rocket-boat-engine-turbine, the training set comprises parameters such as sensor signal, vibration, temperature, pressure or parameter extracted from finite elements computing. The internal parameters of the system are system configurations, strains, temperatures, stresses, power supplies, materials etc. while the external parameters are weather, radiations, etc. The associated actions may include e.g. modifying vehicle or machine speeds or duty cycles, increasing or decreasing intensity of use, or disturbing the ambient temperature.

The present disclosure further relates to a method for providing a sequence of actions causing the evolution of a complex system from an initial state to a final state.

According to one embodiment, the optimization method comprises a preliminary step of coupling a reinforcement learning algorithm to a digital twin of the complex system. In this embodiment, the digital twin is obtained with the method for generating a digital twin of a complex system as described in the embodiments hereabove.

In particular modes, that method for providing a sequence of actions may be optimal with regard to available information. The notion of optimality may refer to a double optimization process: one based on a generative model in constructing the digital twin, and another based on an RL model relying on that digital twin in determining a suited sequence of actions, or more generally of events. The optimality is further defined with respect to one or more convergence thresholds, e.g. a maximum number of iterations or a minimum value of a distance.

The reinforcement learning algorithm is configured to run an agent through sequences of state-action pairs, observing the rewards that result, and adapting the predictions of a Q function to those rewards until it accurately predicts the best path for the agent to take. That prediction is known as a policy.

According to one embodiment, the optimization method comprises the step of using a policy of the reinforcement learning algorithm to select at least one action to be performed according to an action selection policy and provide the selected one or more actions to the digital twin; wherein the digital twin is configured to implement the selected at least one action to generate an output.

According to one embodiment, the policy is obtained using Markov Chains. A Markov chain is a probabilistic way to traverse a system of states. It traces a series of transitions from one state to another. Alternatively, Monte Carlo Tree Search or Deep learning may be used to train the policy.

The type of actions that may be taken by the agent may be limited by imposing constraints on the agent. These constraints advantageously guide the exploration of the manifold so as to minimize the solution time by only considering the portion of the manifold that is relevant. It also allows to obtain an optimal solution for the given constraints, said optimal solution being robust, accurate and feasible. In the case where the complex system is a biological cell, the constraints may be genes KO, drug absorption, environmental perturbation (such temperature, acidity, light, etc.) or aka external parameters.

According to one embodiment, the optimization method comprises a step of updating parameters of the policy using a reinforcement learning procedure according to a reward signal determined from the discriminator output. Said reward signal may be determined as a distance to the final state.

The method then loops to obtain the optimal path and may continue until a termination criterion is met. The termination criterion may comprise, for example, a specified number of iterations or exceeding a threshold value of a performance metric.

According to one embodiment, at least one value obtained from an iteration of the method is used as initial state.

The iterative operations executed with the RL model strongly rely on the generated digital twin. In particular, they may implement inference modes as developed above about the digital twin. In some implementations, the RL algorithm includes modifying the states, actions and/or time information as entries to the digital twin at each iteration step.

FIG. 2 shows an example generative method for providing a sequence of actions causing the evolution of a complex system from an initial state to a final state. In this embodiment, the method comprises a reinforcement learning algorithm coupled to the digital twin. The reinforcement learning algorithm generates a sequence of actions, each action comprising one or more control commands to control the digital twin to generate digital twin outputs.

The sequence of actions virtually obtained by the RL algorithm on the ground of the digital twin may be effectively applied in the real world, i.e. in the complex system, so as to reach a goal. Alternatively, the sequence of actions may be used for identifying opportunities, until a satisfying process is identified and an effective implementation may take place in the real world. In other implementations, the sequence of actions is exploited for identifying risks, issues or dangers. In this case, provisions are taken in the complex system for preventing prejudicial events. The sequence of actions may instead or further help to correlate really existing situations with simulations obtained with the digital twin, thereby enabling diagnostics.

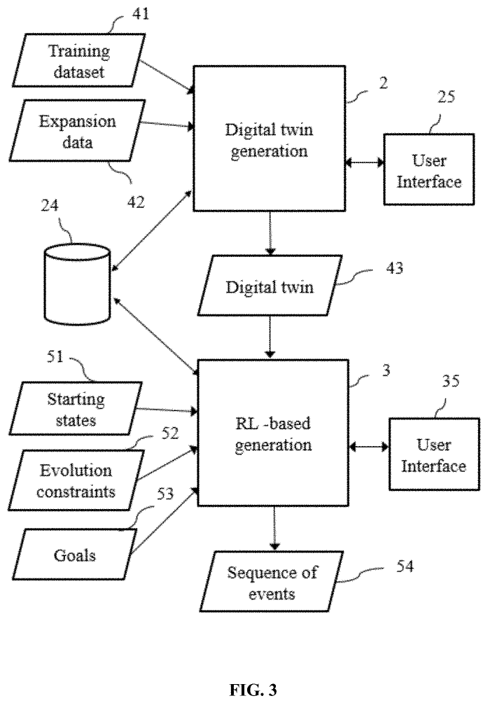

A particular functional embodiment of a device 2 for generating a digital twin of a complex system, as illustrated on FIG. 3, is configured for producing a digital twin 43 by a generative process, from a training dataset 41 including data on states, and associated actions and time information, and from expansion data 42 directed to a desired scope of the digital twin 43. The expansion data 42 may e.g. include state, action and/or time specificities, which can be used in the frame of the generative process.

An associated reinforcement learning device 3 is configured for integrating the digital twin 43 provided by the device 2, receiving starting events 51 (including states, actions and/or possibly time information), evolution constraints 52 and goals 53, and iteratively computing by a reinforcement learning process a sequence of events 54 relevant to the complex system and directed to reaching the goals 53 from the starting states 51 while taking account of the constraints 52. The sequence of events 54 may comprise states, actions, and time data. Alternatively, it may be reduced to the actions, optionally completed with only the associated respective states or only the associated respective time data.

The operations performed by the RL device 3 may be completely disconnected from the previous operations performed by the device 2, and may not require any inputs pertaining to the training dataset 41 or the expansion data 42. Accordingly, the RL device 3 may execute operations entirely within the digital twin 43 as such.

By contrast, in alternative implementations, the RL device 3 further receives some specific parts of the training dataset 41, so as to have reference information potentially useful in iteration steps. It may notably exploit those specific parts to remain close to the training dataset 41, e.g. by introducing in a loss function at least one appropriate minimization term.

Though the presently described devices 2 and 3 are versatile and provided with several functions that can be carried out alternatively or in any cumulative way, other implementations within the scope of the present disclosure include devices having only parts of the present functionalities.

Each of the devices 2 and 3 is advantageously an apparatus, or a physical part of an apparatus, designed, configured and/or adapted for performing the mentioned functions and produce the mentioned effects or results. In alternative implementations, any of the device 2 and the device 3 is embodied as a set of apparatus or physical parts of apparatus, whether grouped in a same machine or in different, possibly remote, machines. The device 2 and/or the device 3 may e.g. have functions distributed over a cloud infrastructure and be available to users as a cloud-based service, or have remote functions accessible through an API.

Also, the device 2 for generating a digital twin and the RL device 3 may be integrated in a same apparatus or set of apparatus adapted to carry out the construction of the digital twin 43 as well as its exploitation through RL, and possibly intended to same users. In other implementations, the structure of device 2 may be completely independent of the structure of device 3, and may be provided for other users. For example, the device 2 may be exploited by a dedicated operator proposing proper digital twin construction to entities provided with RL capabilities embodied in the device 3, either based on instances of the training dataset 41 independently available to the operator (e.g. from an online database or from directly collected relevant image sets), or based on instances provided by the client entities for this purpose. Alternatively, such an operator may be provided with the functionalities of both devices 2 and 3, so as to execute the digital twin generation and RL actions on behalf of the client entities, by receiving instances of the training dataset 41 and by transmitting the induced sequence of events 54 or further derived information, e.g. as subscribeware services (a.k.a. SaaS, for Software as a Service).

The training dataset 41 may be obtained in various ways, and possibly be derived from proprietary data and/or retrieved from remotely available public or private databases, for example from one or more local or remote database(s) 24. The latter can take the form of storage resources available from any kind of appropriate storage means, which can be notably a RAM or an EEPROM (Electrically-Erasable Programmable Read-Only Memory) such as a Flash memory, possibly within an SSD (Solid-State Disk). In variant implementations, the training dataset 41 may be streamed to the device 2.

Likewise, the starting events 51, evolution constraints 52 and goals 53 may be obtained by the device 3 locally and/or remotely, for example from one or more of the local or remote database(s) 24.

The devices 2 and 3 are interacting with respective user interfaces 25 and 35, via which information can be entered and retrieved by a user. Those user interfaces 25 and 35 include any means appropriate for entering or retrieving data, information or instructions, notably visual, tactile and/or audio capacities that can encompass any or several of the following means as well known by a person skilled in the art: a screen, a keyboard, a trackball, a touchpad, a touchscreen, a loudspeaker, a voice recognition system. The user interfaces 25 and 35 may be fused when the devices 2 and 3 are embodied in a same apparatus.

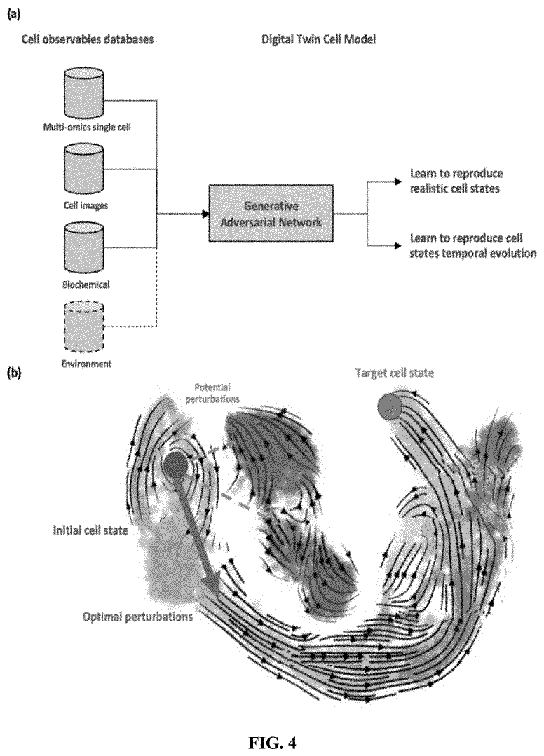

FIG. 4(a) shows a schematic representation of the method for generating a digital twin of a complex system.

FIG. 4(b) shows a schematic representation of the method for providing the optimal sequence of actions causing the evolution of a complex system from an initial state to a final state.

In one embodiment, when the complex system is a biological cell, the method is used to discover optimal strategies to drive the biological cell state from an initial state (i.e. sick) to a final state (i.e. healthy), also called target identification.

In one embodiment when the complex system is a biological cell, the optimization method is used for target identification, drug repurposing or modelling the response of a biological cell to a perturbation, in its environment.

In one embodiment, the optimization method is configured to perform target identification, meaning that the method allows to identify a target, for example a protein, on which actions must be taken so as to pass from the initial state to the final state.

In one embodiment, the optimization method is configured to perform molecule repurposing to find alternative uses for a molecule, i.e. for a given molecule the method is able to find any possible combination of initial state and final state of biological cell up taking said molecule. The method can combine one or many molecules to perturb the initial state toward the desired final state.

An example implementation will now be developed for illustrating a particularly attractive application of the disclosure to biological cells. The aim is to predict a cell response to a perturbation such as a drug. The study is based on sequencing data measuring cell activity at a single cell resolution.

In a preliminary step (preparation of the training dataset), data are ordered in a tabular matrix, such that each row represents a different cell sample and each column a cell component, such as genes. The number of samples ranges e.g. between 10² and 10⁷, the number of genes in human cells amounting to about 20,000.

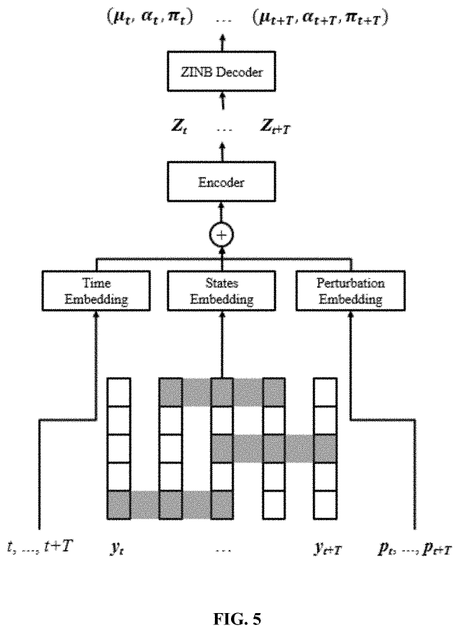

A generative model as illustrated on FIG. 5 is trained for reproducing corrupted temporal sequences of successive cell states. A sequence of time steps {t}_{t∈[t,t+T]} is considered between time steps t and t+T, and a temporal sequence of states {γₜ}_{t∈[t,t+T]} as well as a sequence of corrupted states {γₜ^{c}}_{t∈[t,t+T]} are defined during this period. In addition, a perturbation p is taken into account (which reflects an action). For brevity, the references to the time interval are removed below.

The generative model is of an encoder-decoder type, involving an intermediary latent space of a sequence of states {Zₜ}_{t∈[t,t+T]} The encoder may be a multi-layer perceptron, which is e.g. coupled to multi-head attention as in transformers. From the latent representation, the decoder produces ZINB parameters (Zero-Inflated Negative Binomial distribution) comprising a sequence of triplets (μₜ, αₜ, πₜ) of respectively mean, dispersion and dropout vectorial parameters, from which a predicted cell state γₜ* is sampled.

The generation of the ZINB parameters is further obtained from the corrupted states γₜ^{c}, time t and perturbation p, so that by noting f the associated function:

(μₜ, αₜ, πₜ)=f(γₜ^{c}, t; p) γₜ*˜ZINB(μₜ, αₜ, πₜ)

More will be developed below about the processing of the entries to the generative model, before providing further information on the training process.

An applied time embedding is defined as an OHE (One-Hot Encoding) vector segmenting the state evolution every hour according to genes average temporal evolution.

A perturbation embedding takes likewise as input an OHE vector corresponding to the index of a perturbation library.

As for the samples, they are corrupted by adding a binary mask M to the input, having Bernoulli coefficients defined by hyperparameter optimization. Accordingly:

γₜ^{c}=M⊙γₜ

The masked part of the data (corresponding to zero values in the matrix M) is defined as:

γₜ^{m}=(1−M)⊙γₜ

Turning now to the training process, a model loss is optimized by minimizing a log-likelihood of the masked data, such that:

[symbol]

=−logPr(γₜ^{m}|νₜ^{m}, αₜ^{m}, πₜ^{m})

The above conditioned ZINB probability Pr can be expressed for measuring j times the gene i in the state γ ∈ [symbol] ^{N}, N being the number of genes, by:

$$Pr ( {y}_{i} = j ) = \{ \begin{matrix}{π}_{i} + ( 1 - {π}_{i} ) g ( {y}_{i} = 0 ) & if j = 0 \\ ( 1 - {π}_{i} ) g ( {y}_{i} ) & if j > 0\end{matrix}$$

$$g ( {y}_{i} ) = P r ( Y = {y}_{i} \vert {μ}_{i} , α ) = \frac{Γ ( {y}_{i} + {α}^{- 1} )}{Γ ( {α}^{- 1} ) Γ ( {y}_{i} + 1 )} {( \frac{1}{1 + α {μ}_{i}} )}^{{α}^{- 1}} {( \frac{α {μ}_{i}}{1 + α {μ}_{i}} )}^{{y}_{i}}$$

where Γ is the gamma function, and γᵢ, μᵢ, αᵢ, and πᵢ designate the i^{th} component of respectively a cell state, a mean vector, a dispersion vector and a dropout vector (with α standing for αᵢ in the latter formula).

The thereby obtained digital twin is able to provide predicted cell states over time from observed states, time steps and introduced perturbations, and may then offer a robust representation for exploitation with an RL process.

According to various embodiments in which the digital twin is the digital twin of a car, a city, a building, a rocket, a plane, a drone, a boat, a power plant, a turbine or an engine, similar processes are executed for constructing a proper model suited to downstream RL operations.

The present disclosure further relates to a computer program product for generating a digital twin of a complex system, the computer program product comprising instructions which, when the program is executed by a computer, cause the computer to automatically carry out the steps of the method according to any one of the above described embodiments.

The present disclosure also relates to a computer program product for providing the optimal sequence of actions causing the evolution of a complex system from an initial state to a final state, the computer program product comprising instructions which, when the program is executed by a computer, cause the computer to automatically carry out the steps of the method according to any one of the above described embodiments.

The computer program product to perform the method as described above may be written as computer programs, code segments, instructions or any combination thereof, for individually or collectively instructing or configuring the processor or computer to operate as a machine or special-purpose computer to perform the operations performed by hardware components. In one example, the computer program product includes machine code that is directly executed by a processor or a computer, such as machine code produced by a compiler. In another example, the computer program product includes higher-level code that is executed by a processor or a computer using an interpreter. Programmers of ordinary skill in the art can readily write the instructions or software based on the block diagrams and the flow charts illustrated in the drawings and the corresponding descriptions in the specification, which disclose algorithms for performing the operations of the method as described above.

The present disclosure further relates to a computer readable storage medium comprising instructions which, when the program is executed by a computer, cause the computer to carry out the steps of the method according to any one of the above described embodiments.

According to one embodiment, the computer-readable storage medium is a non-transitory computer-readable storage medium.

Computer programs implementing the method of the present embodiments can commonly be distributed to users on a distribution computer-readable storage medium such as, but not limited to, an SD card, an external storage device, a microchip, a flash memory device, a portable hard drive and software websites. From the distribution medium, the computer programs can be copied to a hard disk or a similar intermediate storage medium. The computer programs can be run by loading the computer instructions either from their distribution medium or their intermediate storage medium into the execution memory of the computer, configuring the computer to act in accordance with the method of this disclosure. All these operations are well-known to those skilled in the art of computer systems.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+ Rs, CD-RWs, CD+ RWs, DVD-ROMs, DVD-Rs, DVD+ Rs, DVD-RWs, DVD+ RWs, DVD-RAMs, BD-ROMs, BD-Rs, BD-R LTHs, BD-Res, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

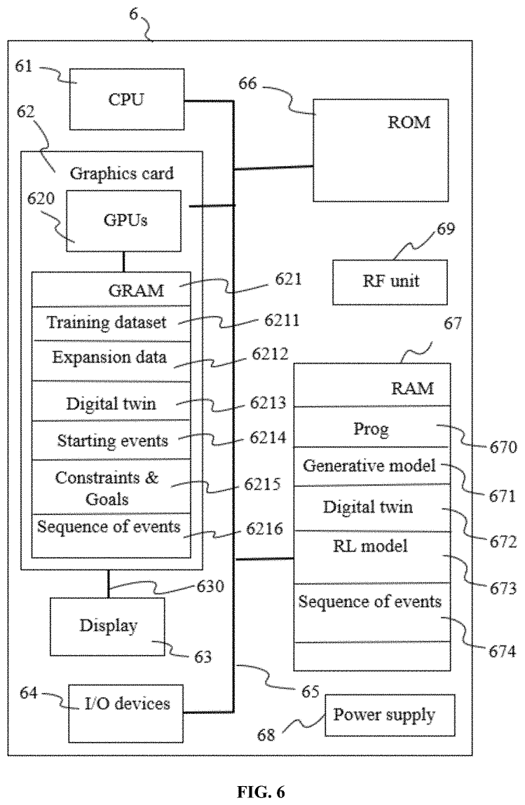

A particular apparatus 6, visible on FIG. 6, is embodying the devices 2 and 3 as described above. It corresponds for example to a mainframe computer, a workstation, a laptop, a tablet, a smartphone, or a head-mounted display (HMD).

That apparatus 6 is suited to providing a digital twin from a training dataset in the above described way, as well as to exploiting this digital twin in an RL process. It comprises the following elements, connected to each other by a bus 65 of addresses and data that also transports a clock signal:
a microprocessor 61 (or CPU);
a graphics card 62 comprising several Graphical Processing Units (or GPUs) 620 and a Graphical Random Access Memory (GRAM) 621; the GPUs are quite suited to repeated computations on the data samples, due to their highly parallel structure;
a non-volatile memory of ROM type 66;
a RAM 67;
one or several I/O (Input/Output) devices 64 such as for example a keyboard, a mouse, a trackball, a webcam; other modes for introduction of commands such as for example vocal recognition are also possible;
a power source 68 ; and
a radiofrequency unit 69.

According to a variant, the power supply 68 is external to the apparatus 6.

The apparatus 6 also comprises a display device 63 of display screen type directly connected to the graphics card 62 to display synthesized target images calculated and composed in the graphics card. The use of a dedicated bus 630 to connect the display device 63 to the graphics card 62 offers the advantage of having much greater data transmission bitrates and thus reducing the latency time for the displaying of images composed by the graphics card, e.g. for ML representations. According to a variant, a display device is external to apparatus 6 and is connected thereto by a cable or wirelessly for transmitting the display signals. The apparatus 6, for example through the graphics card 62, comprises an interface for transmission or connection adapted to transmit a display signal to an external display means such as for example an LCD or plasma screen or a video-projector. In this respect, the RF unit 69 can be used for wireless transmissions.

It is noted that the word “register” used hereinafter in the description of memories 67 and 621 can designate in each of the memories mentioned, a memory zone of low capacity (some binary data) as well as a memory zone of large capacity (enabling a whole program to be stored or all or part of the data representative of data calculated or to be displayed). Also, the registers represented for the RAM 67 and the GRAM 621 can be arranged and constituted in any manner, and each of them does not necessarily correspond to adjacent memory locations and can be distributed otherwise (which covers notably the situation in which one register includes several smaller registers).

When switched-on, the microprocessor 61 loads and executes the instructions of the program contained in the RAM 67.

The random access memory 67 comprises notably:
in a register 670, the operating program of the microprocessor 61;
in a register 671, parameters relevant to the generative model of the device 2;
in a register 672, data pertaining to the digital twin 43;
in a register 673, parameters relevant to the RL model of the device 3;
in a register 674, data pertaining to the sequence of events 54.

Algorithms implementing the steps of the method specific to the present disclosure and described above are stored in the memory GRAM 621. When switched on and once the parameters 671 to 674 are loaded into the RAM 67, the graphic processors 620 of graphics card 62 load appropriate information and parameters into the GRAM 621 and execute the instructions of algorithms in the form of microprograms.

The random access memory GRAM 621 comprises notably:
in a register 6211, the training dataset 41;
in a register 6212, the expansion data 42;
in a register 6213, the digital twin 43;
in a register 6214, the starting events 51;
in a register 6215, the constraints 52 and goals 53;
in a register 6216, the sequence of events 54.

As will be understood by a skilled person, the presence of the graphics card 62 is not mandatory, and can be replaced with entire CPU processing and/or simpler visualization implementations.

In variant modes, the apparatus 6 may include only the functionalities of the device 2 for generating the digital twin, or conversely be relevant to the device 3 for RL processing. In addition, the device 2 and the device 3 may be implemented differently than a standalone software, and an apparatus or set of apparatus comprising only parts of the apparatus 6 may be exploited through an API call or via a cloud interface.

1-15. (canceled)

16. A computer-implemented method for generating a digital twin of a complex system, said method comprising:
receiving at least one training dataset comprising N samples, each sample including information on a state of the complex system and on at least one associated action, the information on said state including time information in relation with said at least one associated action;
training a generative model over states, actions and time information, to learn a topological space which represents an ensemble of attainable states of the complex system reflecting a variability of the training dataset, in an unsupervised fashion over said states, actions and time information, wherein the generative model learns a mapping to realistic samples comprised in the topological space and to realistic state transitions associated with said realistic samples subject to said actions; and
outputting a digital twin including the topological space and transitions between said attainable states subject to said actions, for simulating behaviors of the complex system by means of said digital twin so as to properly achieve at least one task pertaining to the complex system based on said simulated behaviors.

17. The method according to claim 16, wherein in training said generative model, at least part of said states, actions and time information of said N samples is encoded for said training.

18. The method according to claim 17, wherein in training said generative model, at least part of said states of said N samples is subject to a binary mask.

19. The method according to claim 17, wherein in training said generative model, at least part of said actions and time information of said N samples is subject to a one-hot encoding.

20. The method according to claim 16, wherein the generative model is selected among a generative adversarial network, invertible generative model, normalization flows, a variational autoencoder and a transformer.

21. The method according to claim 16, wherein the at least one training dataset is preprocessed for data homogenization and harmonization in distribution.

22. The method according to claim 16, further including mapping the dataset to a latent space in training the generative model.

23. The method according to claim 16, wherein the complex system is selected among a weather of an area, a city, a building, a production line, a power plan, a car, a plane, a drone, a boat, a submarine, a spacecraft, a brain, a biological cell.

24. The method according to claim 23, wherein, for the complex system being a biological cell, the information on a state comprises at least one item of the following:
omics data, such as genomic data, proteomic data, transcriptomic data, epigenomics data or metabolomic data, and/or imaging data.

25. The method according to claim 24, wherein the omics data are single cell sequencing data or bulk sequencing data.

26. The method according to claim 23, wherein, for the complex system being a biological cell, the information on a state further comprises a velocity.

27. A computer-implemented method for providing a sequence of actions causing the evolution of a complex system from an initial state to a final state, the method comprising:
generating a digital twin of the complex system with a method according to claim 16;
coupling a reinforcement learning algorithm to said digital twin of the complex system, by using a policy of the reinforcement learning algorithm to select at least one action to be performed according to an action selection policy and to provide the selected one or more actions to the digital twin, the digital twin being configured to implement the selected at least one action to generate an output, and by updating parameters of the policy using a reinforcement learning procedure according to a reward signal determined from said output, so that the digital twin is iteratively turned from an initial state to a final state, said initial state and final state representing said initial state and final state of the complex system;
outputting the sequence of actions relevant to the complex system and corresponding to said iteratively selected at least one action obtained with the reinforcement learning algorithm applied to the digital twin.

28. A device for generating a digital twin of a complex system, said device comprising:
at least one input adapted to receive at least one training dataset comprising N samples, each sample including information on a state of the complex system and on at least one associated action, the information on said state including time information in relation with said at least one associated action;
at least one processor configured for training a generative model over states, actions and time information, to learn a topological space which represents an ensemble of attainable states of the complex system reflecting a variability of the training dataset, in an unsupervised fashion over said states, actions and time information, wherein the generative model learns a mapping to realistic samples comprised in the topological space and to realistic state transitions associated with said realistic samples subject to said actions; and
at least one output adapted to provide a digital twin including the topological space and transitions between said attainable states subject to said actions, for simulating behaviors of the complex system by means of said digital twin so as to properly achieve at least one task pertaining to the complex system based on said simulated behaviors,
said device being advantageously configured for executing a method for generating a digital twin according to claim 16.

29. A device for providing a sequence of actions causing the evolution of a complex system from an initial state to a final state, comprising a device for generating a digital twin according to claim 25, wherein:
said at least one processor of the device for generating a digital twin is further configured for coupling a reinforcement learning algorithm to said digital twin of the complex system, by using a policy of the reinforcement learning algorithm to select at least one action to be performed according to an action selection policy and to provide the selected one or more actions to the digital twin, the digital twin being configured to implement the selected at least one action to generate an output, and by updating parameters of the policy using a reinforcement learning procedure according to a reward signal determined from said output, so that the digital twin is iteratively transformed from an initial state to a final state, said initial state and final state representing said initial state and final state of the complex system;
said at least one output is adapted to provide the sequence of actions relevant to the complex system and corresponding to said iteratively selected at least one action obtained with the reinforcement learning algorithm applied to the digital twin.

30. A computer program product comprising instructions which, when the program is executed by a computer, cause the computer to automatically carry out the steps of the method for generating a digital twin according to claim 16 or of the method for providing a sequence of actions according to claim 27.
